(19) United States
(12) Patent Application Publication
(10) Pub. No.: US 2024/0375999 A1
(43) Pub. Date: Nov. 14, 2024

(54) METHOD AND PLANT FOR PRODUCING CEMENT CLINKER

(71) Applicant: SCHEUCH MANAGEMENT HOLDING GMBH, Aurolzmünster (AT)

(72) Inventors: Thomas FELLNER, Neukirchen an der Enknach (AT); Georg LECHNER, Schildorn (AT); Christian BARTEL, Lochen am See (AT); Constantin RIEDER, Gmunden (AT)

(21) Appl. No.: 18/685,821

(22) PCT Filed: Oct. 4, 2022
(86) PCT No.: PCT/AT2022/060345

§ 371 Date: Feb. 22, 2024

(30) Foreign Application Priority Data
Oct. 4, 2021 (AT) A 50789/2021

(51) Int. Cl. C04B 7/44; B01D 53/14; B01D 53/26; B01D 53/62; B01D 53/78; B01D 53/96; F23J 15/06; F27D 13/00; F27D 17/00

(52) U.S. Cl. CPC C04B 7/4415; B01D 53/1425; B01D 53/145; B01D 53/1475; B01D 53/265; B01D 53/62; B01D 53/78; B01D 53/96; F23J 15/06; F27D 13/00; F27D 17/004; B01D 2252/204; B01D 2257/504; B01D 2257/80; B01D 2258/0233; B01D 2258/0283; F27D 2013/007

(57) ABSTRACT

The invention relates to a method and plant for producing cement clinker, comprising the steps of: burning raw materials to form cement clinker in a furnace, preheating the raw materials with flue gases of the furnace, and dehumidifying and cooling flue gases of the furnace by means of a condensation heat exchanger.

### TECHNICAL FIELD

The invention relates to a method for producing cement clinker comprising the steps of:
burning raw materials to form cement clinker in a furnace,
preheating the raw materials with flue gases from the furnace.

### BACKGROUND AND SUMMARY

Furthermore, the invention relates to a plant for producing cement clinker, comprising:
a furnace for burning raw materials to form cement clinker,
a preheater for preheating the raw materials with flue gases from the furnace.

The production of cement clinker, as described for example in AT 14170, produces large-volume flue gas streams that are contaminated with pollutants, such as mercury, and climate-damaging greenhouse gases such as carbon dioxide (CO2). Therefore, the operation of cement plants is subject to strict conditions. The emission of pollutants and climate-damaging greenhouse gases is to be reduced. The requirements for energy efficiency are also constantly being increased. These goals are offset by high investment costs associated with the post-treatment of large-volume flue gas streams.

The aim of the invention is to simplify the post-treatment of the flue gas streams of cement clinker production.

This object is achieved by a method and a plant with the features described herein. Preferred embodiments of the invention are given in the dependent claims.

The method according to the invention for producing cement clinker provides the following step:
dehumidifying and cooling flue gases from the furnace by means of a condensing heat exchanger.

Accordingly, the plant for producing cement clinker has a dehumidifying and cooling step with a condensing heat exchanger for dehumidifying and cooling flue gases from the furnace.

Thus, flue gases produced in the furnace, in particular a rotary kiln, are fed to the condensing heat exchanger, with which, on the one hand, the humidity content of the flue gases is reduced and, on the other hand, the flue gases are cooled. The condensing heat exchanger is supplied with a cooling liquid, in particular cooling water, with which the flue gases are cooled below the dew point, in particular below the water vapour dew point, so that the condensable substances, in particular the water vapour, condense. To this end, the condensing heat exchanger comprises at least one heat exchange wall, in particular made of metal, via which the heat exchange between the flue gases and the cooling liquid is made. A shell-and-tube heat exchanger may be provided as heat exchanger. Depending on the embodiment, the shell-and-tube heat exchanger can be divided into two chambers, for example via a partition plate. As a result, one chamber can be scrubbed during operation and the other chamber can be used for heat exchange. Thus, the flue gases emit not only sensitive heat, but also latent heat to the cooling liquid, which is heated accordingly by the heat exchange. The heated cooling liquid is discharged from the condensing heat exchanger. Depending on the embodiment, the heated cooling liquid can be transported to a heat sink where the heat of the cooling liquid can be used. Condensate formed when flowing through the condensing heat exchanger, in particular waste water, is discharged and can be fed to a water treatment system. The essential advantage of the method according to the invention is that the post-treatment of the flue gases downstream of the condensing heat exchanger is made easier because the volume flows of the flue gases have been significantly reduced by the dehumidification.

In the state of the art, cf. in particular EP 1 946 006 B1, the use of a condensing heat exchanger has only been described for a remote application in biomass combustion. With the condensing heat exchanger, an improvement in efficiency is sought in this state of the art. For this purpose, water is deliberately injected into the hot exhaust gas in order to deliberately increase the dew point of the exhaust gas before the exhaust gas enters the condensing heat exchanger.

In contrast, in a variant of the method according to the invention, no additional water is injected into the flue gas stream from the outside, but only the humidity already present in the flue gases from the furnace is used for the condensation.

In a further variant of the method according to the invention, the injecting of water achieves a separation of pollutants, such as acid gases and dust. Furthermore, the (latent) heat energy output at the condensing heat exchanger can be increased by the higher water content in the exhaust gas. This can lead to better heat utilisation from the flue gas.

For the purposes of this disclosure, the directional indications, such as “before”/“upstream, “after”/“downstream”, relate to the flow direction of the flue gases.

The water vapour dew point depends in particular on the composition of the flue gas. When the flue gases are cooled to a temperature of less than 50° C., in particular less than 45° C., for example less than substantially 40° C., by means of the condensing heat exchanger, the desired condensation of the flue gases from cement clinker production can be reliably achieved.

In a particularly preferred embodiment, the following method step is also carried out: cleaning the flue gases, for example with a Regenerative Thermal Oxidation (RTO) and/or with a flue gas desulphurisation (DeSOx) and/or a denitrification (DeNOx), before dehumidifying and cooling the flue gases by means of the condensing heat exchanger. Various embodiments of cleanup steps for cleaning the flue gases from the furnace are known in the state of the art. The flue gases can thus be cleaned before the flue gases are dehumidified with the aid of the condensing heat exchanger and thereby cooled from a temperature of 80° C. to 300° C., in particular substantially 200° C., to a temperature of less than 50° C., in particular less than 45° C., for example less than 40° C.

The condensing heat exchanger is advantageously designed as a multiple time stage one, with which residual proportions of acid gases, in particular sulphur dioxide (SO2) and/or hydrogen chloride (HCl) and/or heavy metals, in particular mercury, in the flue gases are reduced after cleaning. Furthermore, a reduction in odour and a de-steaming of the flue gas can be achieved.

In another embodiment, dehumidifying and cooling the flue gases by means of the condensing heat exchanger may take place between preheating and cleaning the flue gases. For this purpose, the condensing heat exchanger can be interposed between a preheater, for preheating the raw materials before entering the furnace, and a cleanup stage, for cleaning the flue gas from the furnace, so that the flue gases are dehumidified and cooled after the preheater by means of the condensing heat exchanger before the flue gases enter the cleanup stage. In a further embodiment variant, two condensing heat exchangers are provided, wherein one condensing heat exchanger is arranged between the preheater and the cleanup stage and the other condensing heat exchanger is arranged after the cleanup stage.

In a preferred embodiment, after dehumidifying and cooling, the flue gases are recycled into the furnace by means of the condensing heat exchanger. It is particularly advantageous that the volume of the flue gas is reduced after the condensation, as a result of which the dimensions of downstream plant components, such as filter, fan, mill and, if appropriate, also a flue gas cleanup line, can be reduced.

In another preferred embodiment, the flue gases, after dehumidifying and cooling by means of the condensing heat exchanger, are supplied to a Carbon Capture and Utilisation (CCU) or Carbon Capture and Storage (CCS) unit for separating carbon dioxide. In this embodiment, dehumidifying and cooling with the condensing heat exchanger has the particular advantage that the flue gases comprise a minimum water content at low temperatures when entering the CCU/CCS unit, thereby ensuring sufficient sorption of the carbon dioxide in the CCU/CCS unit. Furthermore, the proportion of acid gases and heavy metals can be reduced with the condensing heat exchanger to such an extent that the carbon dioxide (CO2) can be effectively separated with the CCU/CCS unit.

When entering the condensing heat exchanger, the flue gas originating from the furnace, preferably a rotary kiln, preferably comprises a carbon dioxide (CO2) fraction of 10 to 90 percent by volume (% v/v), in particular of 15 to 30% v/v. Alternatively, in particular in an oxyfuel process, the flue gas can comprise a proportion of more than 90% v/v CO2.

In a first preferred embodiment, the CCU or CCS unit is configured to absorb carbon dioxide in a scrubbing liquid. Thus, the carbon dioxide can be absorbed at the scrubbing liquid. Amines respectively aqueous solutions of potassium hydroxide or amino acid salts, organic solvents such as methanol or polyglycol dialkyl ether can be provided as scrubbing or absorption liquid. In a preferred embodiment, the CCU or CCS unit comprises an amine scrubber. The amine scrubber preferably comprises an absorber and a desorber. An aqueous amine solution and the flue gases are introduced into the absorber. Due to the chemical reaction of the absorbed CO2 with the amine solution releases energy in the form of heat. The cleaned flue gas leaves the absorber. The amine solution loaded with CO2 (and if appropriate with residues of other acid gases) is fed into the desorber. In the desorber, the chemical equilibrium is reversed at high temperature via the use of thermal energy and low pressure, and thus the bound CO2 is removed from the amine solution. Thus, the CO2 can be removed by the desorber. By means of a condenser, fractions of amine solution and water can be separated from the CO2 gas stream and recycled.

In a further preferred embodiment, the CCU or CCS unit is configured to absorb carbon dioxide in a solid matter.

In one variant, the CCU/CCS unit is configured for a dry adsorption process with a solid sorbent, for example a zeolite, a functionalised polymer or an organometallic matrix compound. In another variant, the CCU/CCS unit is configured for a cryogenic process in which the CO2 is separated by desublimation or liquefaction. In another variant, the CCU/CSU unit is configured for a process using membrane technology for CO2 separation.

In the aforementioned embodiments, it is advantageous for the flue gases to have been cooled beforehand, for example from 200° C. to a lower temperature of 40° C. In the cryogenic methods, the condensing heat exchanger may be configured as the first of a plurality of cooling stages. The dehumidification prevents the formation of ice, which could lead to clogging of the equipment. The prior cooling of the flue gas or exhaust gas flow is also advantageous when temperature-sensitive membranes or sorbents are used. In general, in processes based on sorption (be it absorption in scrubbing liquids or adsorption on solid sorbents), the sorption works better at lower temperatures, as it is usually an exothermic process. In both absorption and adsorption processes, a desorber can be provided in which the CO2 is separated from the respective sorbent. The energy required for desorption can be provided in the form of heat.

Heat obtained during dehumidification and cooling of the flue gases by means of the condensing heat exchanger is preferably used for the desorption of the carbon dioxide.

To improve the energy balance, it is in particular beneficial if the heat obtained during dehumidifying and cooling of the flue gases by means of the condensing heat exchanger is used for desorption of the carbon dioxide, preferably in the amine scrubber. For example, the temperature of the heated cooling liquid from the condensing heat exchanger may be raised to the required temperature level for desorption via a heat pump.

The flue gas is preferably fed to the condensing heat exchanger in the flow direction of the flue gases downstream of the preheater, in particular with a CO2 content of 10 to 90% v/v, in particular 15 to 30% v/v, dehumidified and cooled with the condensing heat exchanger and then fed to the CCU/CCS unit as seen in the flow direction of the flue gases.

Additionally or alternatively, the heat obtained during dehumidifying and cooling of the flue gases by means of the condensing heat exchanger can be used to dry the raw materials and/or a fuel of the furnace.

The plant for producing cement clinker preferably comprises a flue gas cleanup stage, in particular an RTO and/or desulphurisation stage, which is interposed between the preheater and the dehumidification and cooling stage.

In a particularly preferred embodiment, the condensing heat exchanger comprises a feed line and discharge line for a cooling liquid, the discharge line preferably being connected to a CCU/CCS unit, preferably to an amine scrubber, in particular to an evaporator of a desorber of the amine scrubber.

The invention will be explained in more detail below with reference to exemplary embodiments illustrated in the drawings.

### BRIEF DESCRIPTION OF THE FIGURES

FIG. 1 shows a functional diagram of an embodiment according to the invention, in which the flue gases are dehumidified and cooled by means of a condensing heat exchanger after a flue gas cleanup before the flue gases are used to dry the raw materials or the fuel or are recycled into the rotary kiln.

FIG. 2 shows a functional diagram of a further embodiment according to the invention, in which the dehumidified and cooled flue gases are fed to a CCU/CCS unit for separating the carbon dioxide.

### DETAILED DESCRIPTION

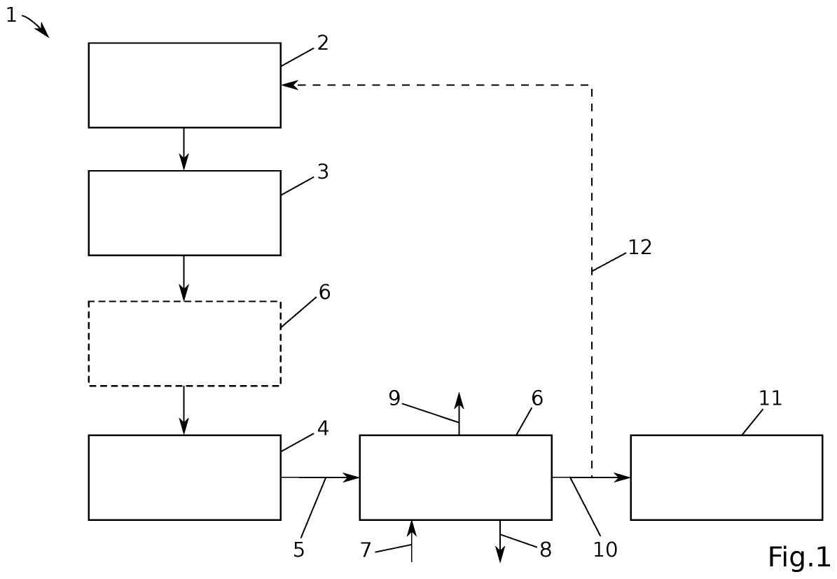

FIG. 1 shows a plant 1 for producing cement clinker, which is part of a cement plant. The plant 1 comprises a furnace 2, in particular a rotary kiln, in which raw material, in particular raw meal, is sintered to form cement clinker. In addition, a preheater 3, in particular a preheating tower, is provided, preferably having a cyclone cascade with a plurality of cyclones (not shown) connected in series. In the preheater 3, the raw material is preheated with the aid of flue gases from the furnace 2 before entering the furnace 2. At the upper end of the preheater 3, the flue gases are drawn off. As usual, the plant 1 comprises a cleanup stage 4 with which the flue gases drawn off from the preheater 3 can be cleaned. An RTO (Regenerative Thermal Oxidation) stage, for example, may be provided as cleanup stage 4. The flue gases leave the cleanup stage 4 at temperatures of, for example, approx. 200° C. (cf. arrow 5).

In the embodiment shown, the flue gases are fed after the cleanup stage 4 to a condensing heat exchanger 6, which comprises a feed line 7 for a cooling liquid, preferably at a temperature of less than 20° C., and a discharge line 8 for the heated cooling liquid, preferably at a temperature of more than 40° C. In addition, the condensing heat exchanger 6 comprises an outlet 9 for the condensate that is produced during the condensation of the flue gases in the condensing heat exchanger 6. The outlet 9 can be connected to a water treatment stage. The flue gases coming from the cleanup stage 4 are dehumidified and cooled by means of the condensing heat exchanger 6. The temperature of the flue gases at the exit of the condensing heat exchanger 6 is preferably less than 40° C. (cf. arrow 10). The heat content of the cleaned, dehumidified and cooled flue gases can be used with the aid of a drying stage 11 to dry, for example, the raw materials or a fuel.

Additionally or alternatively, the flue gases can be recycled downstream of the condensing heat exchanger 6 into the cement clinker production, in particular into the rotary kiln (cf. dashed line 12). This embodiment is particularly suitable for the so-called oxyfuel process, in which the flue gases are returned to the furnace and, at the same time, pure oxygen is supplied in order to maintain combustion. In this way, the proportion of CO2 in the flue gases increases, which significantly increases the CO2 separation potential. The recirculation of the flue gases is also used to transport the heat in the cementing process.

In a further embodiment variant, the condensing heat exchanger 6 may be interposed between the preheater 3 and the flue gas cleanup stage 4, so that the flue gases are dehumidified and cooled downstream of the preheater 3 by means of the condensing heat exchanger 6 before the flue gases enter the cleanup stage 4.

In a further embodiment variant, two condensing heat exchangers 6 are provided, wherein one condensing heat exchanger 6 is arranged between the preheater 3 and the cleanup stage 4 and the other condensing heat exchanger 6 is arranged downstream of the cleanup stage 4.

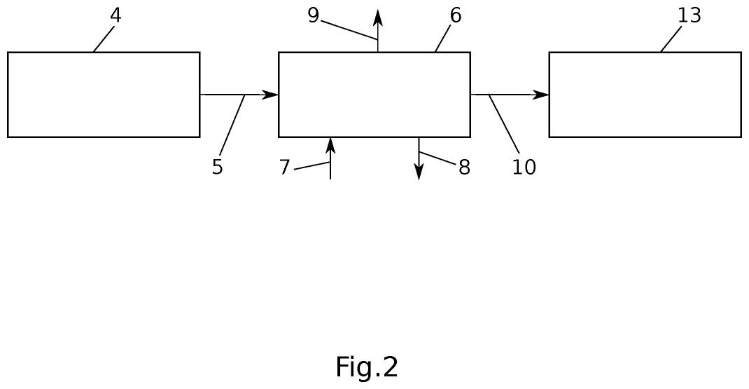

FIG. 2 shows an alternative embodiment wherein the flue gases, after dehumidifying and cooling by means of the condensing heat exchanger, are supplied to a Carbon Capture and Utilisation (CCU) or Carbon Capture and Storage (CCS) unit 13. This CCU/CCS unit 13 is configured to separate the carbon dioxide in the flue gases. In a favourable embodiment variant, the CCU/CCS unit 13 comprises an amine scrubber. The amine scrubber comprises an absorber and a desorber, which may be connected to the discharge line 8 for the heated cooling liquid of the condensing heat exchanger 6 to provide heat for desorption of the carbon dioxide from the amine solution.

1. A method for producing cement clinker, comprising the steps of:
burning raw materials to form cement clinker in a furnace,
preheating the raw materials with flue gases from the furnace, and
dehumidifying and cooling flue gases from the furnace by means of a condensing heat exchanger.

2. The method according to claim 1, wherein the flue gases are cooled by means of the condensing heat exchanger to a temperature of less than 50° C.

3. The method according to claim 1, further comprising
cleaning the flue gases with a Regenerative Thermal Oxidation (RTO) and/or with a flue gas desulphurisation (DeSOx) before dehumidifying and cooling the flue gases by means of the condensing heat exchanger.

4. The method according to claim 1, wherein the flue gases are recycled into the furnace after dehumidifying and cooling by means of the condensing heat exchanger.

5. The method according to claim 1, wherein the flue gases, after dehumidifying and cooling by means of the condensing heat exchanger, are supplied to a Carbon Capture and Utilisation (CCU) or Carbon Capture and Storage (CCS) unit for separating carbon dioxide.

6. The method according to claim 5, wherein the CCU or CCS unit is configured for absorption of carbon dioxide in a scrubbing liquid.

7. The method according to claim 6, wherein the CCU or CCS unit comprises an amine scrubber.

8. The method according to claim 5, wherein the CCU or CCS unit is configured for adsorption of carbon dioxide on a solid.

9. The method according to claim 5, wherein heat obtained during dehumidifying and cooling of the flue gases by means of the condensing heat exchanger is used for desorption of the carbon dioxide.

10. The method according to claim 7, wherein heat obtained during dehumidifying and cooling of the flue gases by means of the condensing heat exchanger is used for desorption of the carbon dioxide in the amine scrubber.

11. The method according to claim 1, wherein heat obtained during dehumidifying and cooling of the flue gases by means of the condensing heat exchanger is used to dry the raw materials and/or a fuel of the furnace.

12. A plant for producing cement clinker, comprising:
a furnace for burning raw materials to form cement clinker,
a preheater for preheating the raw materials with flue gases from the furnace, and
a dehumidifying and cooling stage comprising a condensing heat exchanger for dehumidifying and cooling flue gases of the furnace.

13. The plant for producing cement clinker according to claim 12, comprising
a flue gas cleanup stage interposed between the preheater and the dehumidifying and cooling stage.

14. The plant for producing cement clinker according to claim 12, wherein the condensing heat exchanger comprises a feed line and a discharge line for a cooling liquid.

15. The method according to claim 2, wherein the flue gases are cooled to a temperature of less than 45° C.

16. The method according to claim 2, wherein the flue gases are cooled to a temperature of less than substantially 40° C.

17. The plant for producing cement clinker according to claim 13, wherein the flue gas cleanup stage is an RTO and/or a desulphurisation stage.

18. The plant for producing cement clinker according to claim 14, wherein the discharge line is connected to a CCU or CCS unit.

19. The plant for producing cement clinker according to claim 18, wherein the discharge line is connected to an amine scrubber of the CCU or the CCS unit.

20. The plant for producing cement clinker according to claim 19, wherein the discharge line is connected to an evaporator of a desorber of the amine scrubber.
